(19) United States
(12) Patent Application Publication
(10) Pub. No.: US 2009/0241722 A1
(43) Pub. Date: Oct. 1, 2009

(54) WIRE ORDERING DEVICE OF BICYCLE

(76) Inventor: Yuan-Hung Wen, Changhua County (TW)

Correspondence Address: Chien-Hui Su, P. O. Box 70-121 Taichung, Taichung City, 40899, TW

(21) Appl. No.: 12/057,385

(22) Filed: Mar. 28, 2008

(51) Int. Cl. F16C 1/26

(52) U.S. Cl. 74/502.6

(57) ABSTRACT

A wire ordering device of a bicycle comprises an enclosing layer; at least one auxiliary enclosing end extending from the enclosing layer; and at least one retaining sheet formed on the enclosing layer or the auxiliary enclosing end; after enclosing a tube-like structure of a bicycle, an axial direction of the enclosing layer being different from the that of the auxiliary enclosing end. The enclosing layer can enclose a body of a bicycle. As a wire is to be attached to the body, the retaining sheet will retain a wire upon the body of the bicycle. The wire ordering device of a bicycle has the effect of enclosing the body of a bicycle so as to protect the tubes enclosed by the enclosing layer to avoid wires attached to the body to rub the body of the bicycle.

### FIELD OF THE INVENTION

The present invention relates to bicycles, and particularly to a wire ordering device of a bicycle, wherein the bicycle body can be enclosed by an enclosing layer. In that, the wire ordering device is cut from the enclosing layer so that a wire can be well retained to a bicycle.

### BACKGROUND OF THE INVENTION

In one prior art Taiwan Patent No. 083207346 about positioning of a bicycle barking wire, in that an automatic braking and positioning device is provides, which includes an engaging unit, a hook unit and a positioning ring. The distal end of the engaging unit is engaged to the distal end of the hook unit. The positioning ring serves to hook a brake wire. An outer side of the engaging unit is protruded with the positioning ring. A front end of the engaging unit is protruded with a locking sheet an interior of which has a threaded hole. A front end of the hook unit is protruded with a lock sheet. The lock sheet is formed with a stepped hole. By the engaging unit matching the hook unit to engage the supporting rod of the bicycle, the lock sheet thereof will lock the locking sheet so to as form a positioning assembly. By locking the positioning assembly, the wires can be positioned firmly.

In above mentioned structure, although it can fix the barking wire and speed-change wire to a bicycle body, but the engaging unit is uni-directional structure. The positioning ring will fix the braking wire firmly. However in assembly the bicycle structure, a greater force to pull the wire will make the engaging unit to displace to as to destroy the surface of the bicycle body, even the core of the wire will protrude out from the skin of the wire.

### SUMMARY OF THE INVENTION

Accordingly the object of the present invention is to provides a wire ordering device of a bicycle, other than retaining brake wire and speed change wire of a bicycle, the present invention has the effect of protecting the body of the bicycle, which is suitable for the bicycles of various materials so as to have the effect of stability and convenience.

To achieve above object, the present invention provides a wire ordering device of a bicycle, comprising an enclosing layer made of metal sheet with specific shape; the enclosing layer being flexible; at least one auxiliary enclosing end extending from the enclosing layer; after enclosing a tube-like structure of a bicycle, an axial direction of the enclosing layer being different from the that of the auxiliary enclosing end, for example, enclosing the connections of the front tube and upper tube or the connection of upper tube and seat tube; or the connection of five-stub tube; and at least one retaining sheet formed on the enclosing layer or the auxiliary enclosing end; When it is desired to enclose the brake wire or speed change wire to the body of the bicycle, the enclosing layer encloses the tube in advance and then the retaining sheet will be curved and then retain the wires to the tube body so that the wires are attached to the tubes in order.

The wire ordering device of a bicycle has the effect of enclosing the body of a bicycle so as to protect the tubes enclosed by the enclosing layer to avoid wires attached to the body to rub the body of the bicycle. The enclosing layer is shaped to suit the tube assembly of a bicycle which is suitable for the shape and size of the bicycle. The surplus metal after cutting can be melt for reuse so that the assembly work is easy and the cost can be reduced. The axial directions of the enclosing layer and the auxiliary enclosing end are different. In pulling wire, the enclosing layer and auxiliary enclosing end can interact with one another so as to avoid an overlarge force to generate axial displacement to destroy the body of the bicycle.

The various objects and advantages of the present invention will be more readily understood from the following detailed description when read in conjunction with the appended drawing.

### BRIEF DESCRIPTION OF THE DRAWINGS

FIGS. 1, 2, 3, 4, and 5 are schematic views showing a wire ordering device of a bicycle according to the present invention.

FIG. 4A is an enlarged schematic view of the part A in FIG. 4.

FIGS. 6 to 8 are schematic views about the application of the wire ordering device of a bicycle according to the present invention.

FIG. 9 is a schematic view showing another application of the wire ordering device of a bicycle according to the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

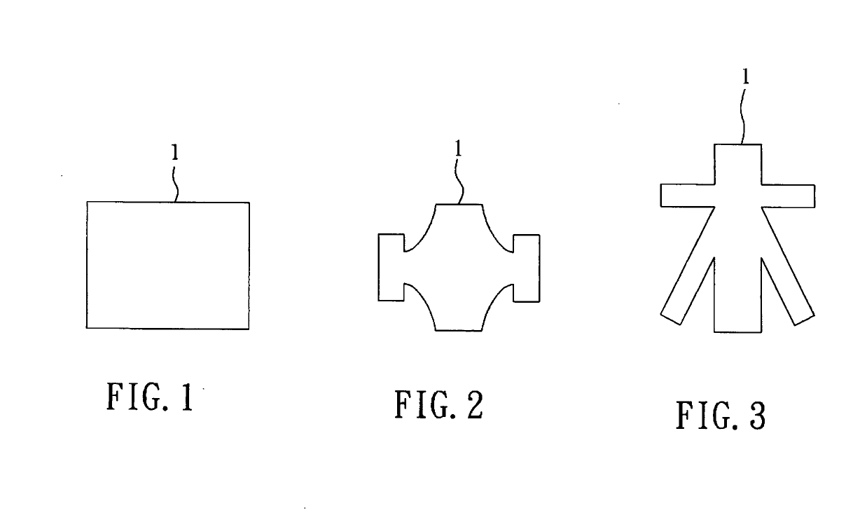

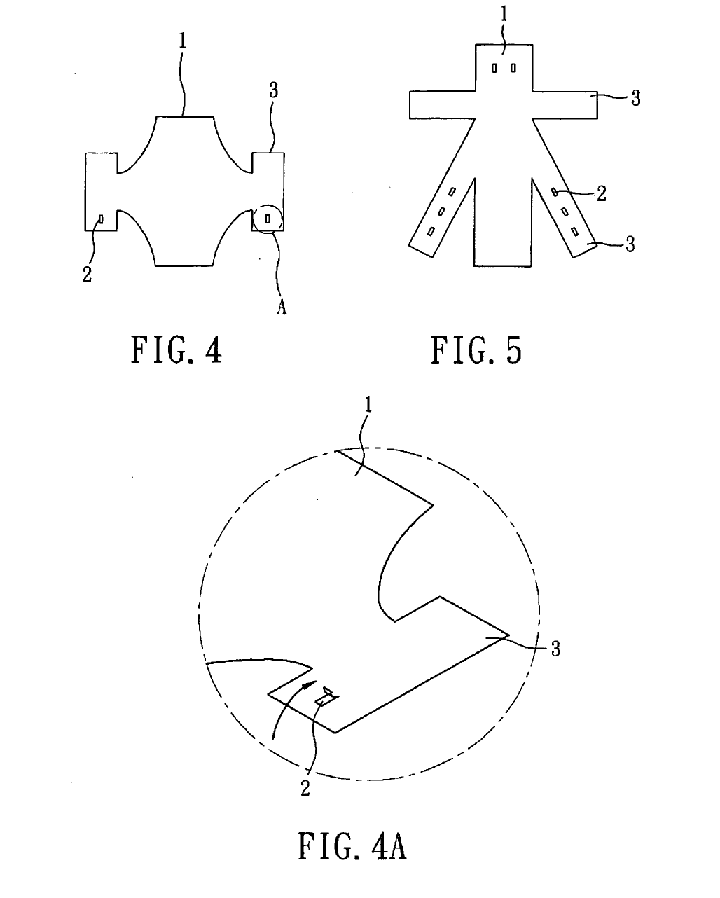

Referring to FIGS. 1 to 5, the wire ordering device of a bicycle according to the present invention is illustrated.

The device has an enclosing layer 1 which is made by cutting metal sheet with a specific shape. However the enclosing layer 1 is not confined to be made by metal, other flexible hard material is permissible. By the flexibility of the metal, the enclosing layer 1 can enclose a tube assembly of a bicycle, such as a connection of a front tube, an upper tube or a seat tube or a five-stub tube. One end of the enclosing layer 1 is formed with an auxiliary enclosing end 3 which presents different enclosing effect from the enclosing layer 1. Then each tube of a bicycle can be enclosed effectively.

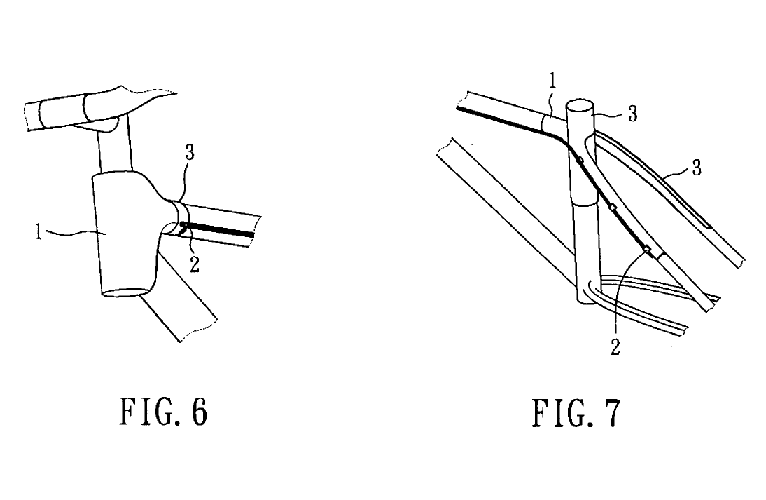

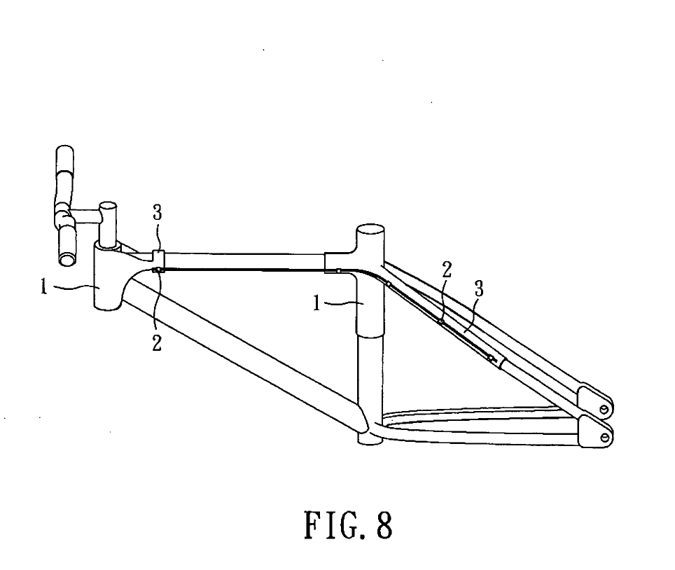

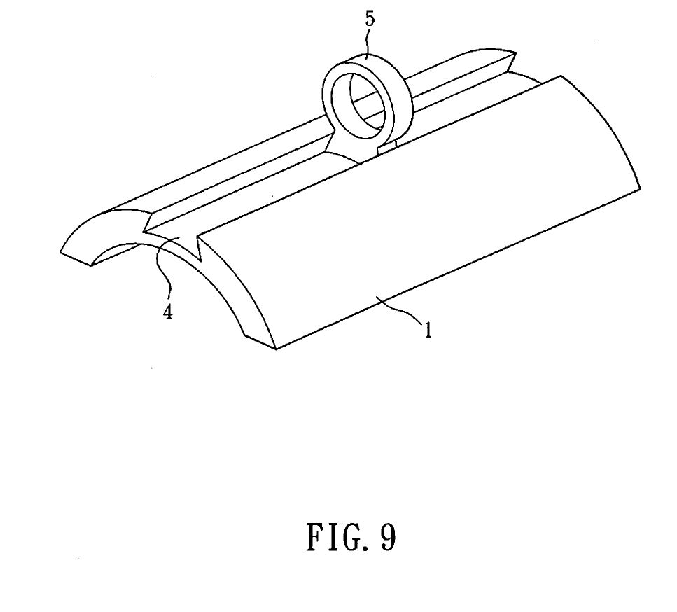

With referring to FIGS. 6 to 8, when the wires of a bicycle are to be fixed (in the drawing, the connection of the front tube, upper tube and seat tube is used as an example, but this is not used to confine the scope of the present invention). Firstly, the connection of the tubes attached with wires are enclosed in advance. Then the auxiliary enclosing end 3 encloses one tube. Then the wires are attached. Then the retaining sheet 2 formed on the auxiliary enclosing end 3 is curled to enclose the wire so that the wire can be attached to the outer side of the enclosing layer 1 in order.

Referring to FIG. 9, another the present invention of the present invention is illustrated. The enclosing layer 1 or auxiliary enclosing end 3 is formed with a sliding groove 4. At least one retaining sheet 5 is formed on the sliding groove 4. The retaining sheet 5 has a hole for receiving the wire to be attached to the tube of a bicycle.

From above description, it is known that by the enclosing layer 1 to enclose a bicycle, the wire of a bicycle will not rub the tube of the bicycle. The shape of the enclosing layer 1 and the auxiliary enclosing end 3 can be made according to the size and shape of the tube assembly of the bicycle. The surplus metal in making the enclosing layer 1 can be melt for reuse. Thus the cost can be reduced. The retaining sheet 2 has the effect of fixing the wire to the tube so as to avoid that the wire is destroyed in repair.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A wire ordering device of a bicycle, comprising
an enclosing layer,
at least one auxiliary enclosing end extending from the enclosing layer; and
at least one retaining sheet formed on the enclosing layer or the auxiliary enclosing end; after enclosing a tube-like structure of a bicycle, an axial direction of the enclosing layer being different from the that of the auxiliary enclosing end;
wherein the enclosing layer can enclose a body of a bicycle and as a wire is to be attached to the body, the retaining sheet will retain a wire upon the body of the bicycle.

2. The wire ordering device of a bicycle as claimed in claim 1, wherein the enclosing layer is flexible and deformable and the retaining sheet is capable of being curved for retaining wires upon the body of the bicycle.

3. The wire ordering device of a bicycle as claimed in claim 1, wherein the retaining sheet is a cut portion from the enclosing layer, and the retaining sheet is capable of being curved for retaining wires upon the body of the bicycle.

4. The wire ordering device of a bicycle as claimed in claim 1, wherein the enclosing layer includes at least one sliding groove for installing a retaining sheet.

5. The wire ordering device of a bicycle as claimed in claim 4, wherein the retaining sheet has a hole for receiving a wire to be attached to the bicycle.
